(19) United States
(12) Patent Application Publication
(10) Pub. No.: US 2016/0009005 A1
(43) Pub. Date: Jan. 14, 2016

(54) METHOD OF FORMING A WIND TURBINE BLADE

(71) Applicant: Siemens Aktiengesellschaft, Muenchen (DE)

(72) Inventors: Kristian R. Dixon, Boulder, CO (US); Justin L. Mullings, Golden, CO (US)

(21) Appl. No.: 14/326,503

(22) Filed: Jul. 9, 2014

(51) Int. Cl. B29C 43/04; B29C 45/00; B29C 43/58; B29C 43/14; B29C 43/34; B29C 43/52; B29C 35/02; B29C 45/76

(52) U.S. Cl. CPC B29C 43/04; B29C 35/0288; B29C 45/00; B29C 45/76; B29C 43/14; B29C 43/34; B29C 43/52; B29C 43/58; B29C 2043/043; B29L 2031/085

(57) ABSTRACT

A method including: curing a casting (18) of a wind turbine blade in a mold (12); and initiating and then stopping a rotation of the mold during the step of curing. By repositioning the mold, a rate of deformation for any given location can be reduced, and previously formed deformations can be decreased in size. In addition, repositioning the mold may be useful to help distribute a curable material (42), such as epoxy resin, throughout a cavity (20) that defines the blade.

### FIELD OF THE INVENTION

The invention relates generally to the field of wind turbines, and more particularly to a method of manufacturing a wind turbine blade.

### BACKGROUND OF THE INVENTION

Wind turbine blades may be formed using a wind turbine blade mold that includes two outer mold parts that fit together around a mandrel. When so arranged, the two outer mold parts and the mandrel define a cavity that takes the profile of the wind turbine blade to be formed. Fibers are positioned within the cavity, and a curable material (such as an epoxy resin) is injected into the cavity. Injection of the curable material may be expedited by various techniques, such as by using a vacuum to draw the curable material through the cavity.

The industry is trending towards larger wind turbines. A larger wind turbine may require a larger blade, and with an increase in blade size is an exponential increase in a structural volume and/or mass of a root section of the blade. Due to this increase in mass and volume, there are growing manufacturing issues associated with the root section. Consequently, there is room in the art for improvement.

### BRIEF DESCRIPTION OF THE DRAWINGS

The invention is explained in the following description in view of the drawings that show:

FIG. 1 is a schematic representation of an exemplary embodiment of a rotating wind turbine mold apparatus.

FIG. 2 is a cross section along A-A of FIG. 1.

FIG. 3 is the cross section along A-A of FIG. 2, rotated one half turn.

FIG. 4 is the cross section of A-A of FIG. 3, rotated one quarter turn.

FIG. 5 is an alternate exemplary embodiment of a rotating wind turbine mold apparatus.

### DETAILED DESCRIPTION OF THE INVENTION

The present inventors have recognized that the increasing size and mass of the wind turbine blade casting is creating a root section of the casting so large that it is deforming under its own weight during the curing process. The resulting deformation of the root section from its design profile causes the root section to cure in a deformed/non-optimal profile.

A root section having an undesired cured profile gives rise to a number of issues, including, but not limited to: additional circumferential fatigue and buckling issues; tolerances beyond accepted criteria leading to difficulty when connecting the root section to a hub of the wind turbine; and bending stresses in the bolts connecting the root section to the hub. Each of these issues increases the likelihood of a failure in the wind turbine.

The present inventors have devised an innovative method for reducing and/or eliminating this gravity-induced deformation altogether. The inventors propose to repeatedly reposition the mold while the curing material cures. By repositioning the mold, a rate of deformation for any given location can be reduced, and previously formed deformations can be decreased in size.

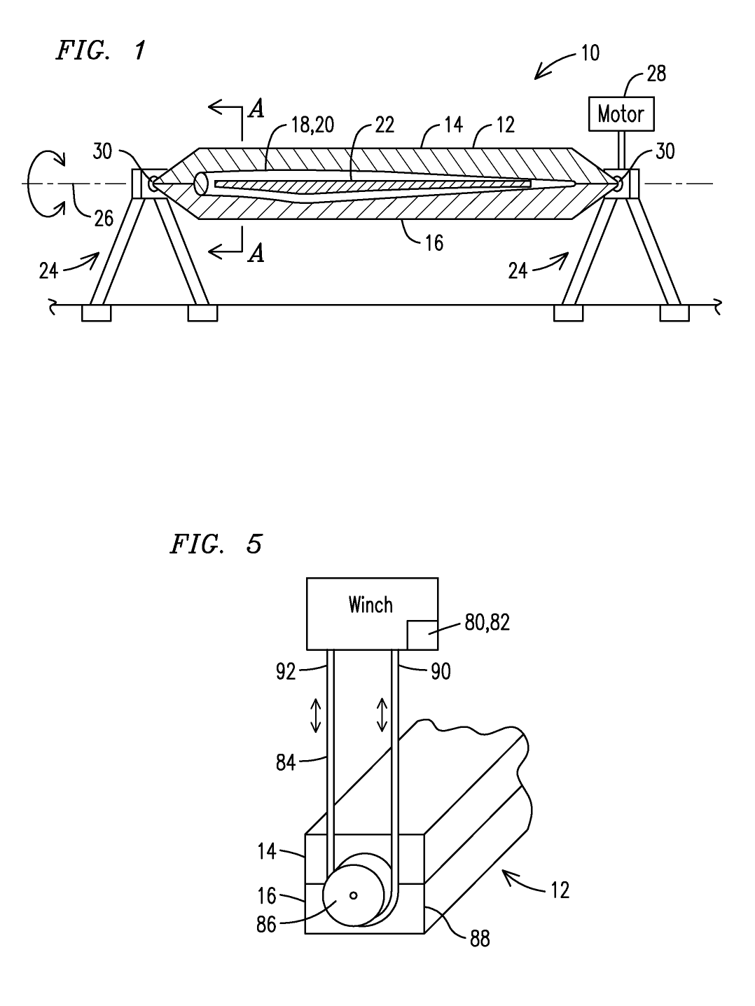

FIG. 1 is a schematic representation of a rotating wind turbine mold apparatus 10 including a wind turbine blade mold 12 having a top half 14, a bottom half 16, and a wind turbine blade casting 18 in a cavity 20 formed between the mold halves and a mandrel 22. The mold 12 is positioned on a stand arrangement 24 that is configured to rotate the mold 12 about a long axis 26 of the mold 12. In an exemplary embodiment, the rotation may be accomplished using, for example, a motor 28 and bearings 30. In another exemplary embodiment, the rotation may be accomplished simply by picking up the mold 12 and rotating it, obviating the need for the motor 28 and bearings 30.

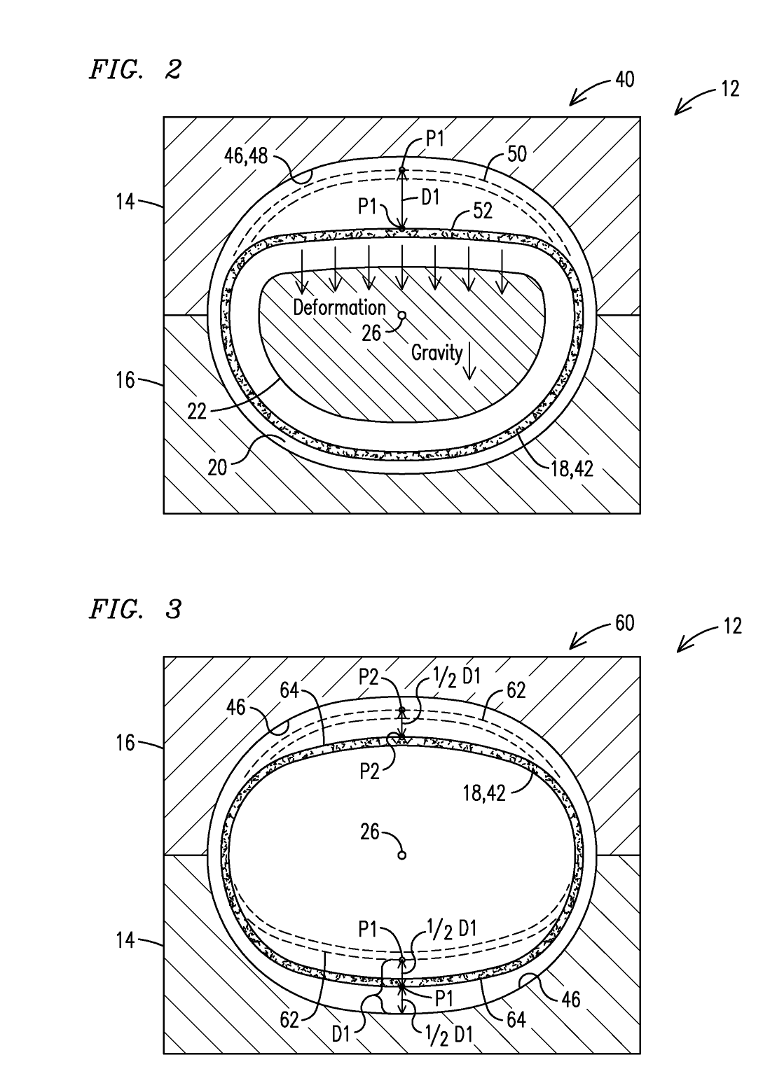

FIG. 2 is a cross section along A-A of FIG. 1 when the mold 12 is in a first mold position 40, and after a curable material 42 of the casting 18 has been injected into the cavity 20. An inner surface 46 of the mold 12 defines a design profile 48 for the casting 18. In this position the casting 18 first exhibits an initial profile 50 that is as close as is possible to the design profile 48. After a period of time T1 in this position the casting 18 exhibits a subsequent profile 52 as a result of the force of gravity acting on the flexible fibers and curable material 42 of the casting 18. During this process a first point P1 of the casting 18 has deformed by a distance D1 from the initial profile 50 to the subsequent profile 52. If this deformation were left uncorrected, the profile of the cured blade would include the deformation, and so point P1 would be a distance D1 from its design position.

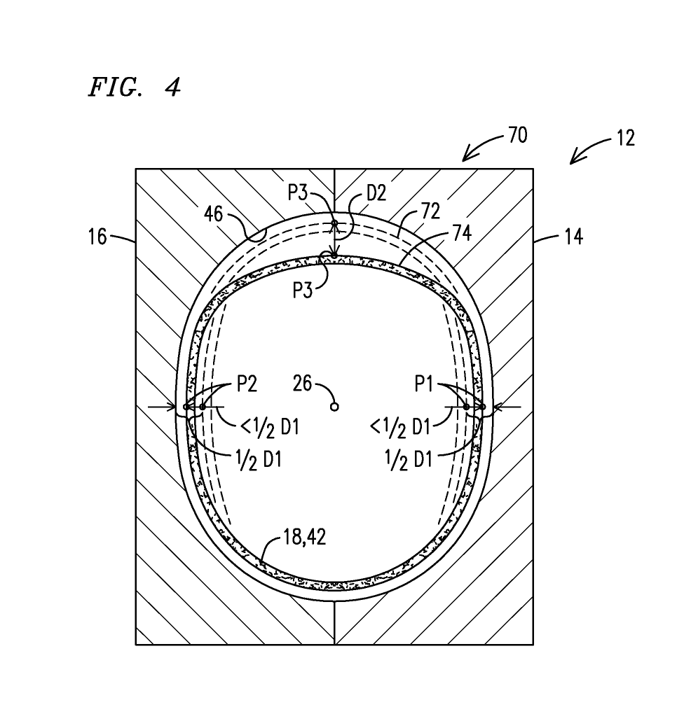

In an exemplary embodiment of the method disclosed herein, FIG. 3 depicts the cross section of FIG. 3 after the mold 12 has been rotated one hundred eighty degrees to a second mold position 60. This rotation may occur in either the clockwise direction or the counterclockwise direction. Point P1 is now at the bottom, and point P2 is now at the top. If the mold 12 is held in this new position for a period of time, T2, the casting 18 will again begin to deform from an initial profile 62, which includes the deformation incurred in the first mold position 40, to a subsequent profile 64. (In FIGS. 3-4 the deformation and gravity arrows have been removed to reduce clutter.) If the time T2 in the second mold position 60 equals the time T1 in the first mold position 40, it is possible that point P1 would return to the design profile. However, it is likely that point P2 would deform just like point P1 did in the first mold position 40. If the time T2 in the second mold position 60 is relatively less than the time T1 in the first mold position 40, point P2 may still deform, but it may be to a lesser amount. For example, if the time T2 spent in the second mold position 60 is half that time T1 spent in the first mold position 40, and if, for explanation purposes, the deformation is linear with time, then P2 may deform half of the distance D1 that P1 deformed. In addition, P1 is still influenced by gravity, but now in the opposite direction, and the mandrel (not shown for clarity) inside the casting 18 contributes to the downward motion of point P1. Consequently, P1 is pulled closer to the design profile 48 by a distance of, in this exemplary embodiment, ½D. If the process were to stop here, then points P1 and P2 would both have deformed from the design profile 48, but each would have only deformed by ½D, which is a marked reduction over the D1 that P1 initially experienced. These reduced distances equal reduced deviations from the design profile. Hence, while more of the cross section of the casting 18 may actually deform, deformed point P1 is brought closer to the design profile 48, and this may be more desirable. In other words, while more of the root section may deform, the average deformation is less.

In an exemplary embodiment of the method disclosed herein, FIG. 4 depicts the cross section of FIG. 3 after the mold 12 has been rotated 90 degrees to a third mold position 70. This rotation may occur in either the same direction the mold 12 rotated between FIGS. 2 and 3, or it may occur in the opposite direction. Point P1 is now at the right, point P2 is now at the left, and a point P3 is at the top. Similar to FIG. 2, if the mold 12 is held in the third mold position 70 for a time T3, then the casting 18 will begin to deform from an initial profile 72, which includes the deformations incurred in the second mold position 60, to a subsequent profile 74. Point P3 may begin to deform. However, the mandrel (not shown) inside the casting 18 will urge points P1 and P2 outward, the action of the mandrel being possibly aided by the deformation of point P3. Since points P2 and P3 are at a distance of ½D from the design profile 48 in the initial profile 72, and since they will be urged toward the design profile 48 as the casting 18 deforms to the subsequent profile 74, dwelling in the third mold position 70 will tend to bring points P1 and P2 to respective positions that are less than ½D from the design profile 48. As happened when going from the first mold position 40 to the mold second position 60, more of the cross section of the casting 18 deforms (now including P3), but points P1 and P2 are brought even closer to the design profile 48. The amount of deformation permitted for P3 may vary and may be selected to meet design criteria.

While this exemplary embodiment shows three mold positions 40, 60, 70, there may be as many or as few mold positions as is deemed desirable. Further, the amount of angular displacement need not be limited to ninety or one hundred eighty degrees, but may be any amount deemed desirable. Likewise, the mold 12 may be rotated the same direction between stops, or it may be rotated in alternating directions between stops, or it may be rotated in any sequence of directions deemed desirable. In an exemplary embodiment, a stepper motor may be used and the mold rotated by a discrete angular displacement, stopped, and the process repeated as many times as desirable, from one stop during the curing to as many stops as the configuration will permit during the curing. The discrete angular displacements may be equal between each stop, or some or all may be unequal. Likewise, the dwell times for each stop may be equal, or some or all may be unequal. Further, the direction of rotation may be the same between stops, may alternate, or may follow any pattern. Consequently, the movement may follow a predetermined pattern of angular displacements, rotation directions, and stops, and/or it may determine the next best angular displacement, rotation direction, and dwell time based on feedback from the sensors monitoring the curing and deformation. As more stops are utilized, more of the casting 18 may deform, but the actual profile deviates less, on average, from the design profile.

Further, the mold 12 may be held in any of the stopped positions for any amount of time. In an exemplary embodiment, the shortest amount of time would be the minimum amount of time necessary to change directions and start rotating the mold 12 in the other direction. In this exemplary embodiment the mold 12 may simply be rotated for a selected angular displacement, stopped long enough to permit a change in direction of rotation, and then rotated for another selected angular displacement. These minimum stop times may not be used, or may be used for some or all of the stops.

FIG. 5 depicts an alternate exemplary embodiment of the rotating wind turbine mold apparatus 10. In this exemplary embodiment, instead of or in addition to being supported by a stand arrangement 24, the mold may be suspended and/or rotated by an overhead crane utilizing, for example, a winch. There may be a single cable 84 coiled one or more times around a spool 86 disposed on an end 88 of the mold 12 such that by retracting one end 90 of the cable 84 the mold 12 rotates in a counterclockwise direction, and by retracting another end 92 of the cable 84 the mold 12 rotates in a clockwise direction. In exemplary embodiments where the mold 12 does not continue to rotate in the same direction, there is no need for the large rotating joints necessary to facilitate transfer of the curable material 42 into the cavity 20 that exist for continually rotating arrangements. This is an advantage, because those rotating joints can be expensive, complex, and prone to failure. In such an exemplary embodiment, all of the plumbing/tubing necessary would only need to be long enough to permit a maximum angular displacement of, for example, less than three hundred sixty degrees.

Alternately, there may be two or more winches 82 at each end 88 and the mold 12 can be rotated by retracting one winch cable and extending the other. Alternately, the weight of the mold 12 may be supported by a stand arrangement 24, while the winches effect the rotation. Any combination can be used so long as it is capable of supporting the mold 12 and rotating the mold 12 about its long axis 26.

In addition to the above advantages, the method may be useful to help distribute the curable material 42 throughout the cavity 20. There is a limit as to, for example, how much vacuum can be applied to the mold 12 and its associated components (mandrels, vacuum bags, injection system etc.). As blades get larger, problems are encountered, and even more problems are anticipated, when a fixed vacuum pressure is required to pull large amount of curable material 42 (such as epoxy resin) through a larger (and exponentially increasing) volume of fibers, (such as glass fibers). This increases the chances that the curable material 42 will not fully permeate the cavity 20, possibly leaving dry spots. These dry spots require special attention after the molding process, and thereby incur time and expense. By rotating and then stopping the mold 12, the force of gravity on the curable material 42 can be used to guide the curable material 42. This process can then be used to ensure the curable material 42 reaches all areas of the cavity 20, and thus dry spots can be mitigated or eliminated altogether. In this manner the rotation helps distribute the curable material 42 not through centrifugal forces, but instead by orienting the cavity 20 in such a way as to allow gravity to cause the distribution. Centrifugal forces may be negligible during rotation and nonexistent when the mold is stopped.

When the mold 12 is rotated and stopped in a manner that also guides the curable material 42, then the motion is serving a dual purpose: to mitigate/prevent deformation, and to aid in the distribution of the curable material 42. In such an exemplary embodiment, movement characteristics such as the magnitude of the angular displacement between stops, the time taken to accomplish the angular displacement, and the dwell time at the stops etc. may take into consideration deformation factors as well as distribution factors. Since the curable material 42 flows through the entire cavity 20, from a base of the blade to a tip of the blade, and since the blade is not symmetric along its length, and since the injection points for the curable material and the vacuum points may not be uniformly distributed around the cavity 20, it may be that at times the distribution factors take priority over the deformation factors.

For example, there may be a particular angular position that is favored in order to facilitate distribution of the curable material 42 due to an asymmetric shape of the casting 18 at, for example, the max-cord portion of the casting 18. To properly distribute the curable material 42, perhaps the mold 12 might need to maintain the particular angular position for a time longer than deformation factors alone would permit. The result is the necessary distribution of the curable material 42 at the example max-cord portion of the casting 18, but at the expense of greater deformation of the root portion during that stop. However, once the curable material 42 is distributed as necessary, the deformation factors may then take priority, and the extra deformation incurred may be mitigated and/or removed. When all factors are considered, such as when the particulars of the root section of the casting 18 are taken into account, and/or when there are multiple factors being considered simultaneously, such as deformation factors and distribution factors, it is evident that the movement characteristics may be varied in any manner necessary to accomplish the deformation mitigation and/or distribution etc. The resulting motions may not appear to be symmetric, or to have an apparent pattern, and this is within the scope of the disclosure.

In addition, the root section or any section may be monitored during the casting and curing operations for deformation and the movement characteristics may be adjusted in response to a detected deformation. A sensor such as a strain gauge or an optical gauge etc may compare a design profile to an existing profile, and or may monitor a change in the profile in one or all angular positions of the mold 12. A processor may receive sensor inputs regarding the deformation and may be programmed to adjust the movement characteristics in response to the sensor inputs. For example, perhaps experience indicates a particular amount of deformation may be expected under certain conditions. A base pattern of movement may be developed for the casting and curing operations. However, the processor may be configured to adjust from the base pattern in response to the deformation sensed during the instant casting and curing operation. Alternately, the processor may be configured to alert so an operator can make manual adjustments.

Similarly, the casting may be monitored while the curable material 42 is infused into the cavity 20 and the movement characteristics may be adjusted in response to less than expected distribution. A sensor such as an optical gauge or a pressure gauge etc. may be used to check for the presence of the curable material 42. The sensor may be positioned, for example, in a location where it is known to be difficult for the curable material 42 to reach. The same processor or a separate processor may receive the sensor inputs regarding the distribution of the curable material 42 and may be programmed to adjust the movement characteristics in response to the sensor inputs. The processor may also be programmed to select the best movement characteristics given the sometimes conflicting deformation and distribution parameters. Alternately, the processor may be configured to alert so an operator can make manual adjustments.

The method disclosed herein may be used in conjunction with other known techniques, such as by adding additional layers of fiber, and/or adding stiff interfaces in the ply layup. However, an advantage of the method disclosed herein is that it does not add mass and complexity to the blade like the conventional techniques do. It is also possible to rotate and stop the mold 12 about a short axis of the mold 12. This may be particularly helpful in aiding the distribution of the curable material 42.

From the foregoing it can be seen that the inventors have devised a simple, yet effective method for tolerance control of a root section of a wind turbine blade casting. Wind turbine castings made using this method have an average actual profile that is closer to the design profile, and have better distribution of the curable material 42. Better average adherence to the design profile reduces circumferential fatigue and buckling issues, improves ease of connection to the hub, and reduces bending stresses in the bolts that connect the blade to the hub. In addition, the method enables greater distribution of the curable material, and this reduces rework necessary to fill in dry spots. This represents a cost and time savings. Consequently, the method represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method, comprising:
curing a casting of a wind turbine blade in a mold; and
initiating and then stopping a rotation of the mold during the step of curing.

2. The method of claim 1, wherein the rotation is about a long axis of the mold.

3. The method of claim 1, wherein an angular displacement that occurs between stops is not greater than ninety degrees.

4. The method of claim 1, an angular displacement that occurs between stops is greater than ninety degrees.

5. The method of claim 1, wherein the stopping step occurs during a change in direction of rotation.

6. The method of claim 5, wherein during the rotation a clockwise displacement equals a counter-clockwise displacement.

7. The method of claim 5, wherein during the rotation a clockwise displacement does not equal a counter-clockwise displacement.

8. The method of claim 1, further comprising holding the mold in a stopped position for a dwell time.

9. The method of claim 1, further comprising monitoring a state of material that is curing, holding the mold in a stopped position for a dwell time, and adjusting a length of the dwell time in response to a change in the state of the curing material.

10. The method of claim 1, further comprising monitoring the casting for deformation and adjusting the rotating step to counter the deformation.

11. The method of claim 1, further comprising monitoring a state of material that is curing, and adjusting the rotating step in response to a change in the state of the curing material.

12. The method of claim 1, further comprising increasing an amount of time to complete the rotation as the curing progresses.

13. The method of claim 1, further comprising injecting a curable material into the mold while rotating the mold.

14. The method of claim 1, further comprising using an overhead crane to rotate the mold.

15. A method, comprising:
rotating a mold about a long axis of the mold, wherein the mold comprises:
a casting of a wind turbine blade comprising a material that is curing, and
an inflated mandrel supporting an interior of the casting;
stopping the rotating as the material cures; and
repeating the rotating and stopping steps.

16. The method of claim 15, further comprising injecting curable material while rotating the mold.

17. The method of claim 15, further comprising changing a direction of rotation after stopping the rotating.

18. The method of claim 15, wherein displacements between stops are not greater than one hundred eighty (180) degrees.

19. The method of claim 15, further comprising monitoring the deformation and adjusting the rocking to counter the deformation.

20. The method of claim 15, further comprising holding the mold in a stopped position for a dwell time.
